(19) United States
(12) Patent Application Publication
(10) Pub. No.: US 2025/0324358 A1
(43) Pub. Date: Oct. 16, 2025

(54) STATE TRANSITION OF AN ENERGY SAVING NETWORK

(71) Applicant: LENOVO (BEIJING) LIMITED, Beijing (CN)

(72) Inventors: Ran Yue, Beijing (CN); Lianhai Wu, Beijing (CN); Haiming Wang, Beijing (CN); Hongmei Liu, Beijing (CN); Congchi Zhang, Shanghai (CN)

(21) Appl. No.: 18/855,357

(22) PCT Filed: May 20, 2022
(86) PCT No.: PCT/CN2022/094179

§ 371 Date: Oct. 9, 2024

(51) Int. Cl. H04W 52/02; H04W 68/02; H04W 76/27

(52) U.S. Cl. CPC H04W 52/0206; H04W 68/02; H04W 76/27

(57) ABSTRACT

Methods and apparatuses for state transition of an energy saving network are disclosed. A base unit comprises a processor and a transceiver coupled to the processor, wherein, the processor is configured to determine to perform state transition and transmit, via the transceiver, a state transition notify message.

### FIELD

The subject matter disclosed herein generally relates to wireless communications, and more particularly relates to methods and apparatuses for state transition of an energy saving network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), core network (CN), scheduling request (SR), buffer status report (BSR), configured grant (CG), operation administration and maintenance (OAM), physical cell identity (PCI), carrier aggregation (CA), dual connectivity (DC), secondary node (SN), Universal Time Coordinated (UTC), control resource set (CORESET), transmission/reception point (TRP), reference signal (RS), Discontinuous Reception (DRX), information element (IE), machine learning (ML), artificial intelligence (AI), data radio bearer (DRB).

A UE that supports the feature of network energy saving techniques may be referred to as new UE. A UE that does not support the feature of network energy saving techniques may be referred to as legacy UE. A base unit that supports the feature of network energy saving techniques may be referred to as new base unit. A base unit that does not support the feature of network energy saving techniques may be referred to as legacy base unit. A base unit can be represented by a gNB or a cell. That is, new base unit can be represented by new cell.

The new cell may have different states, e.g. non-sleep state and multiple sleep states.

However, in the prior art, there is no disclosure on how to make state transition of the new cell.

This invention targets state transition of the new cell.

### BRIEF SUMMARY

Methods and apparatuses for state transition of an energy saving network are disclosed.

In one embodiment, a base unit comprises a processor; and a transceiver coupled to the processor, wherein, the processor is configured to determine to perform state transition; and transmit, via the transceiver, a state transition notify message.

In some embodiment, the processor is configured to determine to perform state transition based on a received indication or a predetermined criterion meeting a predetermined threshold. In particular, different predetermined thresholds are used for the state transition to different states.

In some embodiment, the state transition notify message is an indication of state transition or a feedback request for state transition. The state transition notify message may include at least one of: cell ID; time related information on the state transition; state transition information; the configuration after the state transition; and updated paging information.

In some embodiment, the state transition notify message is transmitted to at least one of: UE(s) camping on or being connected to the base unit, neighboring base unit(s); and core network.

In another embodiment, a method performed by a base unit comprises determining to perform state transition; and transmitting a state transition notify message.

In still another embodiment, a UE comprises a processor; and a transceiver coupled to the processor, wherein, the processor is configured to receive, via the transceiver, a state transition notify message from a base unit.

In some embodiment, the processor is further configured to transmit, via the transceiver, a state transition response message to the base unit.

In some embodiment, the state transition notify message includes at least one of: cell ID; time related information on the state transition; state transition information; the configuration after the state transition; and updated paging information.

In some embodiment, the state transition response message includes the UE's preference for the state transition. In particular, the state transition response message may further include suggested configuration of the base unit after the state transition.

In yet another embodiment, a method performed by a UE comprises receiving a state transition notify message from a base unit.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example scenario of state transition of new cell;

FIG. 2 illustrates another example scenario of state transition of new cell;

FIG. 3 is a schematic flow chart diagram illustrating an embodiment of a method;

FIG. 4 is a schematic flow chart diagram illustrating a further embodiment of a method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U. NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

A UE, e.g. in idle (e.g. RRC_IDLE) state, camps on a cell. It means that the UE can receive system information broadcasted by the gNB of the cell. A UE, e.g. in connected (e.g. RRC_CONNECTED) state, is served by at least one cell. It means that, for each of the at least one cell, the UE communicates with the gNB of the cell. Accordingly, a cell can be represented by a gNB. In other words, new cell can be represented by new gNB (or new gNB/cell) or new base unit; while legacy cell can be represented by legacy gNB (or legacy gNB/cell) or legacy base unit.

For clarification, in the following description, if appropriate, new cell is used to represent new gNB, or new gNB/cell, or new base unit; and legacy cell is used to represent legacy gNB, or legacy gNB/cell, or legacy gNB/cell.

The new cell, which supports the feature of network energy saving techniques, may be in non-sleep state (e.g. normal state, active state, etc) or in sleep state. A new gNB/cell is in sleep state means the new gNB/cell is in the state of low energy consumption. There could be multiple sleep states, for example micro sleep state, light sleep state, deep sleep state, etc (note that the name of each sleep state may be different from micro sleep state, light sleep state, and/or deep sleep state). Each of the sleep states corresponds to a different level of energy consumption. The different level of energy consumption may be represented by different state transition time, or by different reference parameters or different configurations or different configuration periods, or by different levels of TX power, or by different levels of power consumption, or by different levels of resource allocation, etc. Each of different levels may be less than 100%. A new gNB/cell is in non-sleep state means the new gNB/cell can utilize the full level of energy. Correspondingly, the state transition time, or TX power, or power consumption, or resource allocation, etc in non-sleep state can be less than or equal to 100% or can be higher than the level in sleep state.

The new gNB/cell in one state may transit to another state.

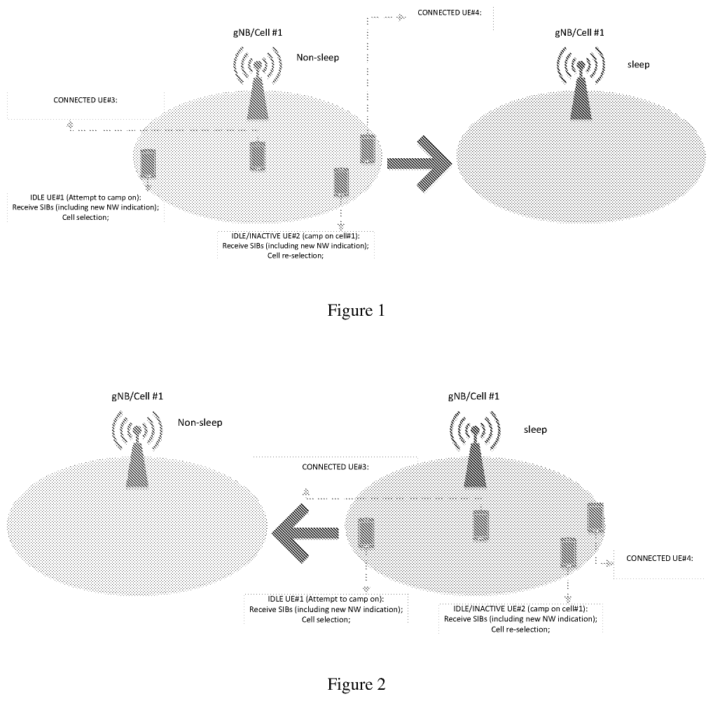

In an example scenario illustrated in FIG. 1, a new cell (e.g. cell #1) is in non-sleep state prepares to transit to one of sleep states. UE #1, UE #2, UE #3 and UE #4 are new UEs. UE #1 and UE #2, that are in idle state or inactive (e.g. RRC_INACTIVE) state, camp or attempt to camp on cell #1. UE #3 and UE #4, that are in connected state, are connected to cell #1.

In an example scenario illustrated in FIG. 2, a new cell (e.g. cell #1) is in one of sleep states prepares to transit to non-sleep state. UE #1, UE #2, UE #3 and UE #4 are new UEs. UE #1 and UE #2, that are in idle state or inactive state, camp or attempt to camp on cell #1. UE #3 and UE #4, that are in connected state, are connected to cell #1.

Also, a new cell may transit from one of the sleep states to another sleep state.

When the new cell transits from one state to another state, is it necessary to negotiate the state transition with the UEs camping on or being connected to the new cell?

In addition, when the new cell transits from one state to another state, is it necessary to negotiate the state transition with the neighboring cells (e.g. neighboring new cells) and/or the core network (CN)?

Moreover, when the new cell has transited from one state to another state, what information shall be sent to the UEs camping on or being connected to the new cell, the neighboring cells and the CN?

This disclosure proposes different solutions related to state transition of the new cell.

A first embodiment relates to the decision of state transition.

A first sub-embodiment of the first embodiment relates to determining state transition of a new cell according to the traffic of the UE(s) camping on or being connected to the new cell.

For example, the state transition of a new cell may be triggered if one of the following conditions is met.
(1) Specific traffic(s) arrive, e.g. the data corresponding to the preconfigured DRB or logical channel arrives.
(2) The number of the arrivals of the specific traffic(s) reaches a first predetermined threshold.
(3) The scheduling request (SR) and/or buffer status report (BSR) corresponding to the specific traffic(s) are triggered.
(4) The number of corresponding SRs and BSRs reaches a second predetermined threshold.
(5) UL transmission on CG from UE(s) in connected state arrives.
(6) The number of UL CG transmissions from UE(s) in connected state reaches a third predetermined threshold.

Each of the first predetermined threshold, the second predetermined threshold and the third predetermined threshold can be configured by the CN (e.g. OAM) or pre-defined by the technical specification or up to the implementation of the new cell.

For transition to different states (e.g. non-sleep state or one of the sleep states), each of the first predetermined threshold, the second predetermined threshold, and the third predetermined threshold may be different. It means that each of the first predetermined threshold, the second predetermined threshold, and the third predetermined threshold is a group of thresholds.

In particular, the first predetermined threshold is a group of thresholds (e.g. first predetermined threshold #1, first predetermined threshold #2, etc) each of which is associated with a specific state transition. For example, the new cell may transit from a micro sleep state to a light sleep state if the number of the arrivals of the specific traffic(s) reaches first predetermined threshold #1 (i.e. first predetermined threshold #1 is associated with state transition from micro sleep state to light sleep state), while the new cell may transit from a micro sleep state to a non-sleep state if the number of the arrivals of the specific traffic(s) reaches first predetermined threshold #2 (i.e. first predetermined threshold #2 is associated with state transition from micro sleep state to non-sleep state).

Similarly, the second predetermined threshold is also a group of thresholds (e.g. second predetermined threshold #1, second predetermined threshold #2, etc) each of which is associated with a specific state transition. For example, the new cell may transit from a micro sleep state to a light sleep state if the number of corresponding SR, BS values reaches second predetermined threshold #1 (i.e. second predetermined threshold #1 is associated with state transition from micro sleep state to light sleep state), while the new cell may transit from a micro sleep state to a non-sleep state if the number of corresponding SR. BS values reaches second predetermined threshold #2 (i.e. second predetermined threshold #2 is associated with state transition from micro sleep state to non-sleep state).

Incidentally, the number of the thresholds associated with different state transitions in a predetermined threshold group (e.g. each of the first predetermined threshold, the second predetermined threshold and the third predetermined threshold) can be predetermined based on the supported number of state transitions. For example, for the first predetermined threshold, if 9 state transitions are supported, there would be first predetermined threshold #1, first predetermined threshold #2 . . . , first predetermined threshold #9.

A second sub-embodiment of the first embodiment relates to determining state transition of a new cell according to handover request to the new cell.

For example, the state transition of a new cell may be triggered if one of the following conditions is met.
(7) The number of the received handover requests reaches a fourth predetermined threshold.
(8) The number of the requested reserved resources for handover reaches a fifth predetermined threshold.
(9) The handover request(s) from the specific neighboring cell(s) are received.

Each of the fourth predetermined threshold and the fifth predetermined threshold and the specific neighboring cell(s) can be configured by the CN (e.g. OAM) or pre-defined by the technical specification or up to the implementation of the new cell.

For transition to different states (e.g. non-sleep state or one of the sleep states), each of the fourth predetermined threshold and the fifth predetermined threshold may be different.

A third sub-embodiment of the first embodiment relates to determining state transition of a new cell according to DL data arrival from CN to the new cell.

For example, the state transition of a new cell may be triggered if one of the following conditions is met.
(10) the DL data for a UE which is connected to the new cell arriver at the CN or
(11) the DL arrival data reaches a sixth predetermined threshold.

The sixth predetermined threshold can be configured by the CN (e.g. OAM) or pre-defined by the technical specification or up to the implementation of the new cell.

For transition to different states (e.g. non-sleep state or one of the sleep states), the sixth predetermined threshold may be different.

A fourth sub-embodiment of the first embodiment relates to a new cell determining state transition of the new cell autonomously. The new cell updates its configurations or transmission according to the transited state.

Incidentally, the above described determining can be used as an input to a machine learning (ML) or artificial intelligence (AI) model.

When the state transition of a new cell is determined according to the first embodiment, the state transition of the new cell shall be indicated.

A second embodiment relates to indicating the state transition of the new cell.

A first sub-embodiment of the second embodiment relates to a new cell indicating the state transition of the new cell to UE(s) camping on or being connected to the new cell.

The indication of the state transition of the new cell can be provided from the new cell over Uu interface to the UE(s) camping on or being connected to the new cell by a new notification message, or with new information element(s) (IE) in an existing message.

The indication of the state transition of the new cell can be provided in a dedicated signaling, or in a system broadcast message.

The indication of the state transition of the new cell to the UE(s) camping on or being connected to the new cell may include at least one of the following:
(2-1-1) node ID (or cell ID), e.g. a physical cell identity (PCI) or a SCell index. The node ID (or cell ID) is not necessary if the new cell can only indicate the state transition of the new cell itself to the UE(s) camping on or being connected to the new cell. In other words, if a new cell can indicate the state transition of another node (or another new cell), the node ID (or cell ID) is necessary to be included in the indication. The other node (or the other new cell) can be for example a configured SCell (e.g. for carrier aggregation (CA) or dual connectivity (DC)), or a secondary node (SN) (including PScell and/or SCell), or a deactivated SCell.
(2-1-2) time related information on the state transition, e.g. the state transition is effective on a determined time (e.g. a UTC (Universal Time Coordinated)); or the state transition is effective after a predetermined time, e.g. after a predetermined millisecond or after a predetermined number of slots or after a predetermined number of symbols or after predetermined seconds.
(2-1-3) state transition information, which may be the state to which the new cell (or the cell indicated by the node ID or cell ID) transits, e.g. non-sleep state, or one of sleep states (e.g. micro sleep state, light sleep state, deep sleep state), or transition from which state to which state, e.g. from non-sleep state to sleep state, from non-sleep state to one of sleep states (e.g. from non-sleep state to micro sleep state, from non-sleep state to light sleep state, from non-sleep state to deep sleep state), from sleep state to non-sleep state, from one of sleep states to non-sleep state.
(2-1-4) the configuration of the new cell (or the cell indicated by the node ID or cell ID) after the state transition, e.g. the periodicity of the SSB, the periodicity of the SIB(s), the transmission resources configuration, and/or the TRP configuration (for example, each of the TRPs of the new cell being on or off after the state transition).

Incidentally, a TRP corresponds to a pool of CORESETs with the same CORESETPoolIndex. So, a CORESET pool may indicate a TRP. A particular panel of a UE is used to transmit UL signal to a particular TRP. So, a panel may indicate a TRP. Multiple beams are sent from a panel. In addition, multiple beams used for receiving belong to a TRP. So, a beam or a beam set (or beam group) consisting of multiple beams may indicate a panel, and accordingly indicate a TRP. A beam can be identified by a beam ID; a beam set can be identified by a beam set ID; and a beam group can be identified by a beam group ID. So, a beam ID or a beam set ID or a beam group ID may indicate a panel, and accordingly indicate a TRP. A panel corresponds to a set of reference signals (RSs) (maybe referred to as RS set). So, an RS set may indicate a panel, and accordingly indicate a TRP.
(2-1-5) updated paging information, for example, paging occasion, paging periodicity (e.g. idle paging periodicity, inactive paging periodicity), paging DRX (e.g. paging DRX cycle).

For UE(s) that are not suitable to camp on or be connected to the new cell in the transited state, the new cell would perform handover of the UE(s) to a suitable neighboring cell, or update the configuration of CA or DC for the UE(s).

In a variety of the first sub-embodiment of the second embodiment, the UE(s) camping on or being connected to the new cell may detect the state transition by a new DCI, a new MAC CE or a new LCID. In other words, the indication of the new cell to the UE(s) camping on or being connected to the new cell may be implemented by sending the indication by the new DCI, the new MAC CE or the new LCID. For example, one or two bits in the new DCI may indicate the transited state of the new cell. The variety of the first sub-embodiment of the second embodiment also applies to the new cell autonomously transiting the state. If the new cell autonomously transits the state, the UE may monitor and/or identify the new cell's transmission with the updated configurations (e.g. a different periodicity of SSB or SIB).

A second sub-embodiment of the second embodiment relates to a new cell indicating the state transition of the new cell to neighboring cells.

The indication of the state transition of the new cell can be provided from the new cell over Xn or X2 interface to each of the neighboring cells if the new cell (gNB) and the neighboring cell (neighboring gNB) are two network nodes. Alternatively, the indication of the state transition of the new cell can be provided from the new cell over F1 interface to each of the neighboring cells if one of the new cell and the neighboring cell is IAB-donor and the other is IAB-node. The indication of the state transition of the new cell can be a new notification message, or with new notification IE(s) in an existing message.

The indication of the state transition of the new cell to the neighboring cells may include at least one of the following:
(2-2-1) time related information on the state transition, which is the same as (2-1-2).
(2-2-2) state transition information, which may be the state to which the new cell transits or transition from which state to which state.
(2-2-3) the configuration of the new cell after the state transition, e.g. the periodicity of the SSB, the periodicity of the SIB(s), the transmission resources configuration, and/or the TRP configuration.

Each of the neighboring cells receiving the indication of the state transition of the new cell may determine whether it can be the target cell (target gNB) of a handover initiated by the new cell. In addition, each of the neighboring cells may send back an indication on whether it can be the target cell (target gNB) to the new cell. It can be sent before the handover (e.g. before receiving a handover request from the new cell) or during the handover procedure. The indication can be included in a new message or with new IE(s) in an existing message.

A third sub-embodiment of the second embodiment relates to a new cell indicating the state transition of the new cell to the CN.

The indication of the state transition of the new cell can be provided over NG interface to the CN by a new notification message, or with new IE(s) in an existing message.

The indication of the state transition of the new cell to the CN may include at least one of the following:
(2-3-1) time related information on the state transition, which is the same as (2-2-1).
(2-3-2) state transition information, which is the same as (2-2-2).
(2-3-3) the configuration of the new cell after the state transition, which is the same as (2-2-3).
(2-3-4) updated paging information, for example, paging occasion, paging periodicity (e.g. idle paging periodicity, inactive paging periodicity), paging DRX (e.g. paging DRX cycle).

The CN receiving the indication of the state transition of the new cell may determine whether each neighboring cell of the new cell can be the target cell (target gNB) of a handover initiated by the new cell. In addition, the CN may send, to the new cell, an indication on whether each neighboring cell of the new cell can be the target cell (target gNB). The indication can be sent before handover preparation or during the handover procedure by the new cell. The indication can be included in a new message or with new IE(s) in an existing message.

In addition, if the new cell has neither Xn or X2 interface nor F1 interface with the neighboring cells, the CN may provide the state transition of the new cell to the neighboring cells.

A fourth sub-embodiment of the second embodiment relates to the CN indicating the state transition of a new cell to the new cell.

As described in the third sub-embodiment of the first embodiment, the state transition of a new cell may be triggered by the DL data arrival reaching the sixth predetermined threshold. The DL data arrival reaching the sixth predetermined threshold can be determined by the new cell or by the CN. It means that when the CN determines the DL data arrival (to a new cell) reaching the sixth predetermined threshold, the CN can determine the state transition of the new cell. In this condition, the CN provides the indication of the state transition of the new cell to the new cell

The indication of the state transition of a new cell can be provided from the CN over NG interface to the new cell by a new notification message, or with new IE(s) in an existing message.

The indication of the state transition of a new cell from the CN to the new cell may include at least one of the following:
(2-4-1) time related information on the state transition, which is the same as (2-2-1).
(2-4-2) state transition information, which is the same as (2-2-2).
(2-4-3) the configuration of the new cell after the state transition, which is the same as (2-2-3).
(2-4-4) updated paging information, which is the same as (2-3-4).

The new cell receiving the state transition of the new cell may provide the state transition of the new cell over Uu interface to the UE(s) camping on or being connected to the new cell by a new notification message, or with new IE(s) in an existing message, as described in the first sub-embodiment of the second embodiment.

In addition, the new cell receiving the state transition of the new cell may further provide the state transition of the new cell over Xn or X2 interface or F1 interface to the neighboring cells by a new notification message, or with new IE(s) in an existing message, as described in the second sub-embodiment of the second embodiment. Alternatively, if the new cell has neither Xn or X2 interface nor F1 interface with the neighboring cells, the CN provides the state transition of the new cell over NG interface to the neighboring cells by a new notification message, or with new IE(s) in an existing message.

A third embodiment relates to negotiation of the state transition of the new cell.

The negotiation of the state transition of the new cell means that a feedback request for the state transition of the new cell is transmitted while an optional response to the feedback request is transmitted back. The negotiation of the state transition of the new cell is optionally performed before the indication of state transition of the new cell. The feedback request of the state transition of the new cell may be performed by the new cell with at least one of UE(s) camping on or being connected to the new cell, the neighboring cells and the CN, or by the CN with the new cell, to request for feedback response for the state transition of the new cell before the state transition of the new cell is performed.

A first sub-embodiment of the third embodiment relates to negotiating the state transition of the new cell by the new cell with UE(s) camping on or being connected to the new cell.

Before the new cell indicating the state transition of the new cell or confirming the state transition of the new cell, the new cell may negotiate the state transition of the new cell with the UE(s) camping on or being connected to the new cell. It means that the new cell transmits a feedback request to the UE(s) camping on or being connected to the new cell, and can receive the UE(s)′ feedback on the state transition of the new cell.

The feedback request of the state transition of the new cell by the new cell with the UE(s) camping on or being connected to the new cell can be provided from the new cell over Uu interface to the UE(s) camping on or being connected to the new cell by a new request message, or with new IE(s) in an existing message. The feedback request may include at least one of the following:
(3-1-1) time related information on the state transition, which is the same as (2-1-2) or (2-2-1).
(3-1-2) state transition information. The state transition information may be the state or multiple candidate states to which the new cell transits, or transition from which state to which state(s) (i.e. the state or multiple candidate states to which the new cell transits). It means that the feedback request may provide one state for the UE to accept or reject, or the feedback request may provide multiple candidate states from which the UE can choose one that the UE prefers.
(3-1-3) the configuration of the new cell after the state transition, which is the same as (2-2-3).
(3-1-4) updated paging information, which is the same as (2-1-5).

Upon receiving the feedback request, each UE camping on or being connected to the new cell may send a response to the feedback request.

The response may indicate the UE's preference for the state transition. For example, the UE's preference for the state transition may be one of the following:
(3-1-1′) preference for a specific state of the new cell;
(3-1-2′) acceptance of the feedback request;
(3-1-3′) acceptance of one of the states contained in the state transition information of the request; and
(3-1-4′) rejection of the feedback request.

The response to the feedback request from the UE camping on or being connected to the new cell is optional. If no response is received from a UE camping on or being connected to the new cell, e.g. no response is received within a time duration or within a time window, the new cell assumes that the UE accepts the feedback request (i.e. 3-1-2′).

The response may be provided from the UE over Uu interface to the new cell by a new response message, or with a new response information element in an existing message.

If the response from a UE camping on or being connected to the new cell is rejection of the feedback request (i.e. 3-1-4′), the new cell would consider performing handover of the UE to a suitable neighboring cell, or updating the configuration of CA or DC for the UE.

A second sub-embodiment of the third embodiment relates to negotiating the state transition of the new cell by the new cell with the neighboring cell(s).

Before the new cell indicating the state transition of the new cell or confirming to accept the suggested configuration or confirming the state transition of the new cell, the new cell may negotiate the state transition of the new cell with the neighboring cell(s). It means that the new cell transmits a feedback request to the neighboring cell(s), and can receive the neighboring cell(s)′ feedback on the state transition of the new cell.

The feedback request of the state transition of the new cell by the new cell with the neighboring cell(s) can be provided from the new cell over Xn or X2 interface or F1 interface to the neighboring cell(s) by a new message, or with new IE(s) in an existing message. The feedback request may include at least one of the following:
(3-2-1) time related information on the state transition, which is the same as (3-1-1).
(3-2-2) state transition information, which is the same as (3-1-2).
(3-2-3) the configuration of the new cell after the state transition, which is the same as (3-1-3).

Upon receiving the feedback request, each neighboring cell may send a response.

The response may indicate the neighboring cell's preference for the state transition. For example, the neighboring cell's preference for the state transition may be one of the following:
(3-2-1′) preference for a specific state of the new cell;
(3-2-2′) acceptance of the feedback request;
(3-2-3′) acceptance of one of the states contained in the state transition information of the feedback request; and
(3-2-4′) rejection of the feedback request.

In addition, the neighboring cell's preference for the state transition may alternatively or additionally include (3-2-5′) suggested configuration (e.g. the suggested state, the suggested SSB or resource configuration corresponding to the suggested state, and/or the suggested transition time, etc.) of the new cell after the state transition.

The response from the neighboring cells is optional. If no response is received from a neighboring cell, e.g. no response is received within a time duration or within a time window, the new cell assumes that the neighboring cell accept the feedback request (i.e. 3-2-2′).

The response may be provided from the neighboring cell over Xn or X2 interface or F1 interface to the new cell by a new response message, or with a new response information element in an existing message.

A third sub-embodiment of the third embodiment relates to negotiating the state transition of the new cell by the new cell with the CN.

Before the new cell indicating the state transition of the new cell, or confirming to accept the suggested configuration or confirming the state transition of the new cell, the new cell may negotiate the state transition of the new cell with the CN. It means that the new cell transmits a feedback request to the CN, and can receive the CN's feedback on the state transition of the new cell.

The feedback request of the state transition of the new cell by the new cell with the CN can be provided from the new cell over NG interface to the CN by a new message, or with new IE(s) in an existing message. The feedback request may include at least one of the following:
(3-3-1) time related information on the state transition, which is the same as (3-1-1).
(3-3-2) state transition information, which is the same as (3-1-2).
(3-3-3) the configuration of the new cell after the state transition, which is the same as (3-1-3).

Upon receiving the feedback request, the CN may send a response.

The response may indicate the CN's preference for the state transition of the new cell. For example, the CN's preference for the state transition may be one of the following:
(3-3-1′) preference for a specific state of the new cell;
(3-3-2′) acceptance of the feedback request;
(3-3-3′) acceptance of one of the states contained in the state transition information of the feedback request; and
(3-3-4′) rejection of the feedback request.

In addition, the CN's preference for the state transition of the new cell may alternatively or additionally include (3-3-5′) suggested configuration of the new cell after the state transition. For example, the suggested configuration may include the suggested transition time, updated paging information, etc. The updated paging information may be paging occasion, paging periodicity (e.g. idle paging periodicity, inactive paging periodicity), paging DRX (e.g. paging DRX cycle).

The response from the CN is optional. If no response is received from the CN, e.g. no response is received within a time duration or within a time window, the new cell assumes that the CN accepts the feedback request (i.e. 3-3-2′).

The response may be provided from the CN over NG interface to the new cell by a new response message, or with a new response information element in an existing message.

A fourth sub-embodiment of the third embodiment relates to negotiating the state transition of the new cell by the CN with the new cell.

Before the CN indicating the state transition of a new cell to the new cell or confirming to accept the suggested configuration or confirming the state transition of the new cell, the CN may negotiate the state transition of the new cell with the new cell. It means that the CN transmits a feedback request to the new cell, and can receive the new cell's feedback on the state transition of the new cell.

The feedback request of the state transition of the new cell by the CN with the new cell can be provided from the CN over NG interface to the new cell by a new message, or with new IE(s) in an existing message. The feedback request may include at least one of the following:
(3-4-1) time related information on the state transition, which is the same as (3-1-1).
(3-4-2) state transition information, which is the same as (3-1-2).
(3-4-3) the configuration of the new cell after the state transition, which is the same as (3-1-3).

Upon receiving the feedback request, the new cell may send a response.

The response may indicate the new cell's preference for the state transition of the new cell. For example, the new cell's preference for the state transition may be one of the following:
(3-4-1′) preference for a specific state of the new cell;
(3-4-2′) acceptance of the feedback request;
(3-4-3′) acceptance of one of the states contained in the state transition information of the feedback request; and
(3-4-4′) rejection of the feedback request.

In addition, the new cell's preference for the state transition of the new cell may alternatively or additionally include (3-4-5′) suggested configuration of the new cell after the state transition.

The response from the new cell is optional. If no response is received from the new cell, e.g. no response request is received within a time duration or within a time window, the CN assumes that the new cell accepts the feedback request (i.e. 3-4-2′).

The response may be provided from the new cell over NG interface to the CN by a new response message, or with a new response information element in an existing message.

In the above description, the indication of the state transition of the new cell and the feedback request for the state transition of the new cell are separately described. On the other hand, both the indication of the state transition of the new cell and the feedback request for the state transition of the new cell can be regarded as a state transition notify message since most of the contents of the indication and the negotiation request are the same.

The state transition notify message can be identified as the indication of the state transition of the new cell or the feedback request for the state transition of the new cell according to the contents contained in the state transition notify message. For example, if the state transition notify message is a new message, the new message may contain a 1-bit field to distinguish whether the state transition notify message is the indication of the state transition of the new cell or the feedback request for the state transition of the new cell. For another example, if the state transition notify message is new IEs in an existing message, different new IEs can be used for the indication of the state transition of the new cell and for the feedback request for the state transition of the new cell.

If a feedback request includes all of necessary information on the state transition (e.g. all of 3-1-1, 3-1-2, 3-1-3 and 3-1-4 for the feedback request to the UE(s) camping on or being connected to the new cell and the 3-1-2 include two candidate states (e.g. micro sleep state and light sleep state)), after receiving responses from the UE(s) camping on or being connected to the new cell, neighboring cells and/or the CN, if the new cell determines to transit to one of the candidate states (e.g. the micro sleep state), the following indication of the indication of the state transition of the new cell may only include the determined state (i.e. contained in the state transition information (e.g. 2-1-3)).

Table 1 illustrates an example of new IEs in an existing message (CELL ACTIVATION REQUEST) to implement the indication of the state transition of the new cell to neighboring cells or the negotiation request for the state transition of the new cell with the neighboring cells. NG-RAN node (e.g. NG-RAN node₁, NG-RAN node₂) identifies a cell. The IE “Energy state” may represent the state transition information. The IE “Time info” may represent the time related information on the state transition, where “INTEGER (0 . . . 549755813887)” counts the number of UTC seconds in a unit of 10 ms since 00:00:00 on Gregorian calendar date Jan. 1, 1900 (midnight between Sunday, Dec. 31, 1899 and Monday, Jan. 1, 1900), and “ENUMERATED {sf20, sf40, sf64, sf128, sf512, sf1024, sf2560, spare1}” represents the number of subframes. The IE “Energy off” may represent the configuration of the new cell (e.g. TRP configuration) after the state transition. For example, if the new cell has two TRPs (with TRP index 0 and TRP index 1), ENUMERATED {0, 1} indicates the TRP index of the TRP being off.

TABLE 1
CELL ACTIVATION REQUEST
This message is sent by the NG-RAN node₁ to the peer NG-RAN
node₂ to request a previously switched-off cell/s to be re-activated.
Direction: NG-RAN node₁ → NG-RAN node₂.

| | | | | | | |
|---|---|---|---|---|---|---|
| | | | | Semantics | | Assigned |
| IE/Group Name | Presence | Range | IE type and reference | description | Criticality | Criticality |

| | | | | | |
|---|---|---|---|---|---|
| Message Type | M | | 9.2.3.1 | YES | reject |
| CHOICE Served | M | | | YES | reject |
| Cells To Activate | | | | | |
| >NR Cells | | | | | |
| >>NR Cells | | 1 | | — | |
| List | | | | | |
| >>>NR Cells | | 1 . . . | | — | |
| item | | <maxnoofCellsinNG- | | | |
| | | RANnode> | | | |
| >>>>NR CGI | M | | 9.2.2.7 | — | |
| >>>> Energy | O | | ENUMERATED(Deep | | |
| State | | | Sleep, Light Sleep, . . . ) | | |
| Time Info | | | INTEGER | | |
| | | | (0 . . . 549755813887) | | |
| | | | Or | | |
| | | | ENUMERATED | | |
| | | | {sf20, sf40, sf64, | | |
| | | | sf128, sf512, sf1024, | | |
| | | | sf2560, spare1} | | |
| Energy off | | | ENUMERATED | | |
| | | | {0, 1} | | |
| >E-UTRA Cells | | | | | |

Table 2 illustrates another example of new IEs in an existing message (CELL ACTIVATION REQUEST) to implement the indication of the state transition of the new cell to neighboring cells or the negotiation request for the state transition of the new cell with the neighboring cells.

TABLE 2
Served Cells To Update NR
This IE contains updated configuration information for served NR cells exchanged between NG-RAN nodes.

| | | | IE type and | Semantics | | Assigned |
|---|---|---|---|---|---|---|
| IE/Group Name | Presence | Range | reference | description | Criticality | Criticality |
| Served Cells To | | 0 . . . | | List of | YES | reject |
| Modify NR | | <maxnoofCellsinNG- | | modified cells | | |
| | | RAN node> | | served by the | | |
| | | | | NG-RAN | | |
| | | | | node. | | |
| >Old NR CGI | M | | NR CGI | | — | |
| | | | 9.2.2.7 | | | |
| >Served Cell | M | | 9.2.2.11 | | — | |
| Information NR | | | | | | |
| >Neighbour | O | | 9.2.2.13 | | — | |
| Information NR | | | | | | |
| >Neighbour | O | | 9.2.2.14 | | — | |
| Information E- | | | | | | |
| UTRA | | | | | | |
| >Deactivation | O | | ENUMERATED | Indicates that | — | |
| Indication | | | (deactivated, . . . ) | the concerned | | |
| | | | | cell is | | |
| | | | | switched off | | |
| | | | | for energy | | |
| | | | | saving reasons. | | |
| > Energy State | O | | ENUMERATED(Deep | | | |
| | | | Sleep, Light Sleep, . . .) | | | |
| Time Info | | | INTEGER | | | |
| | | | (0 . . . 549755813887) | | | |
| | | | Or | | | |
| | | | ENUMERATED | | | |
| | | | {sf20, sf40, sf64, | | | |
| | | | sf128, sf512, | | | |
| | | | sf1024, sf2560, | | | |
| | | | spare1} | | | |
| Energy off | | | ENUMERATED | | | |
| | | | {0, 1} | | | |

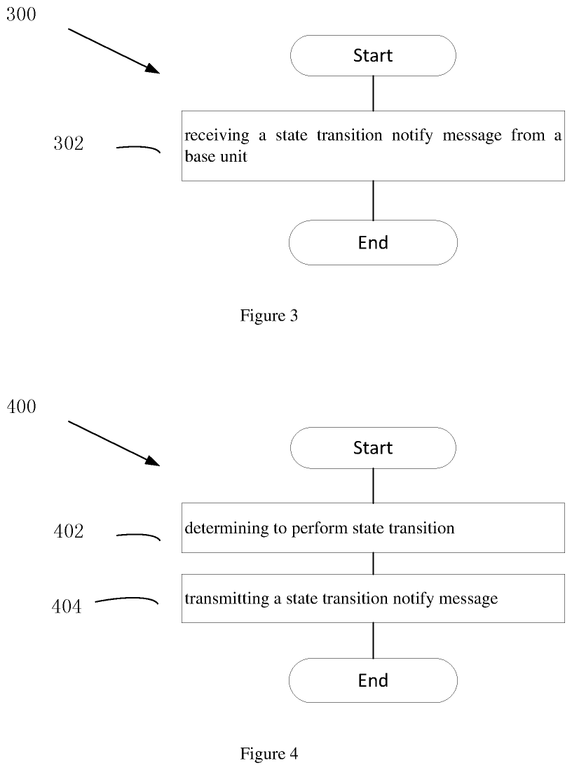

FIG. 3 is a schematic flow chart diagram illustrating an embodiment of a method 300 according to the present application. In some embodiments, the method 300 is performed by an apparatus, such as a remote unit (UE). In certain embodiments, the method 300 may be performed by a processor executing program code, for example, a microcontroller, a microprocessor, a CPU, a GPU, an auxiliary processing unit, a FPGA, or the like.

The method 300 may be performed by a UE and comprise 302 receiving a state transition notify message from a base unit.

In one embodiment, the method 300 may further comprise 304 transmitting a state transition response message to the base unit.

In some embodiment, the state transition notify message includes at least one of: cell ID; time related information on the state transition; state transition information; the configuration after the state transition; and updated paging information.

In some embodiment, the state transition response message includes the UE's preference for the state transition. In particular, the state transition response message may further include suggested configuration of the base unit after the state transition.

FIG. 4 is a schematic flow chart diagram illustrating a further embodiment of a method 400 according to the present application. In some embodiments, the method 400 is performed by an apparatus, such as a base unit or a network device. In certain embodiments, the method 400 may be performed by a processor executing program code, for example, a microcontroller, a microprocessor, a CPU, a GPU, an auxiliary processing unit, a FPGA, or the like.

The method 400 may be performed by a base unit and comprises 402 determining to perform state transition; and 404 transmitting a state transition notify message.

In some embodiment, the determining to perform state transition is based on a received indication or a predetermined criterion meeting a predetermined threshold. In particular, different predetermined thresholds are used for the state transition to different states.

In some embodiment, the state transition notify message is an indication of state transition or a feedback request for state transition. The state transition notify message may include at least one of: cell ID; time related information on the state transition; state transition information; the configuration after the state transition; and updated paging information.

In some embodiment, the state transition notify message is transmitted to at least one of: UE(s) camping on or being connected to the base unit, neighboring base unit(s); and core network.

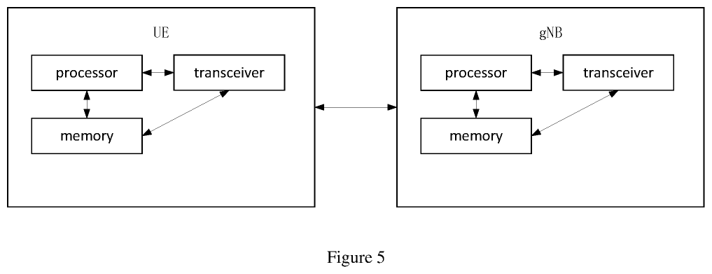

FIG. 5 is a schematic block diagram illustrating apparatuses according to one embodiment.

Referring to FIG. 5, the UE (i.e. remote unit, or terminal device) includes a processor, a memory, and a transceiver. The processor implements a function, a process, and/or a method which are proposed in FIG. 3.

The UE comprises a processor; and a transceiver coupled to the processor, wherein, the processor is configured to receive, via the transceiver, a state transition notify message from a base unit.

In one embodiment, the processor is further configured to transmit, via the transceiver, a state transition response message to the base unit.

In some embodiment, the state transition notify message includes at least one of: cell ID; time related information on the state transition; state transition information; the configuration after the state transition; and updated paging information.

In some embodiment, the state transition response message includes the UE's preference for the state transition. In particular, the state transition response message may further include suggested configuration of the base unit after the state transition.

Referring to FIG. 5, the gNB (i.e. base unit or network device) includes a processor, a memory, and a transceiver. The processor implements a function, a process, and/or a method which are proposed in FIG. 4.

The base unit comprises a processor; and a transceiver coupled to the processor, wherein, the processor is configured to determine to perform state transition; and transmit, via the transceiver, a state transition notify message.

In some embodiment, the processor is configured to determine to perform state transition based on a received indication or a predetermined criterion meeting a predetermined threshold. In particular, different predetermined thresholds are used for the state transition to different states.

In some embodiment, the state transition notify message is an indication of state transition or a feedback request for state transition. The state transition notify message may include at least one of: cell ID; time related information on the state transition; state transition information; the configuration after the state transition; and updated paging information.

In some embodiment, the state transition notify message is transmitted to at least one of: UE(s) camping on or being connected to the base unit, neighboring base unit(s); and core network.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A base station, comprising:
at least one memory; and
at least one processor coupled with the at least one memory and configured to cause the base station to:
determine to perform state transition; and
transmit a state transition notify message.

2. The base station of claim 1, wherein the at least one processor is configured to cause the base station to determine to perform state transition based on a received indication or a predetermined criterion meeting a predetermined threshold.

3. The base station unit of claim 2, wherein different predetermined thresholds are used for the state transition to different states.

4. The base station of claim 1, wherein the state transition notify message is an indication of state transition or a feedback request for state transition.

5. The base station of claim 4, wherein the state transition notify message includes at least one of:
a cell identifier (ID);
time related information on the state transition;
state transition information;
a configuration after the state transition; and
updated paging information.

6. The base station of claim 1, wherein the state transition notify message is transmitted to at least one of:
user equipments (UEs) camping on or being connected to the base station;
neighboring base stations; and
core network.

7. A method performed by a base station, the method comprising:
determining to perform state transition; and
transmitting a state transition notify message.

8. A user equipment (UE), comprising:
at least one memory; and
at least one processor coupled with the at least one memory and configured to cause the UE to:
receive a state transition notify message from a base station unit.

9. The UE of claim 8, wherein the at least one processor is configured to cause the UE to transmit a state transition response message to the base station.

10. The UE of claim 9, wherein the state transition notify message includes at least one of:
a cell identifier (ID);
time related information on the state transition;
state transition information;
a configuration after the state transition; and
updated paging information.

11. The UE of claim 9, wherein the state transition response message includes the UE's preference for the state transition.

12. The UE of claim 11, wherein the state transition response message further includes suggested configuration of the base station after the state transition.

13. A processor for wireless communication, comprising:
at least one controller coupled with at least one memory and configured to cause the processor to:
receive a state transition notify message from a base station.

14. The processor of claim 13, wherein the at least one controller is configured to cause the processor to transmit a state transition response message to the base station.

15. The processor of claim 14, wherein the state transition notify message includes at least one of:
a cell identifier (ID);
time related information on the state transition;
state transition information;
a configuration after the state transition; and
updated paging information.

16. The method of claim 7, further comprising determining to perform state transition based on a received indication or a predetermined criterion meeting a predetermined threshold.

17. The method of claim 16, wherein different predetermined thresholds are used for the state transition to different states.

18. The method of claim 7, wherein the state transition notify message is an indication of state transition or a feedback request for state transition.

19. The method of claim 18, wherein the state transition notify message includes at least one of:
a cell identifier (ID);
time related information on the state transition;
state transition information;
a configuration after the state transition; and
updated paging information.

20. The method of claim 7, wherein the state transition notify message is transmitted to at least one of:
user equipments (UEs) camping on or being connected to the base station;
neighboring base stations; and
core network.
